(19) United States
(12) Patent Application Publication
(10) Pub. No.: US 2025/0361182 A1
(43) Pub. Date: Nov. 27, 2025

(54) GROUT COMPOSITION FOR USE IN CONSTRUCTION AND METHODS OF PREPARING THE SAME

(71) Applicant: ONX, INC., Carrollton, TX (US)

(72) Inventor: Mohamed Kassim Jahaber, George Town (MY)

(21) Appl. No.: 18/674,567

(22) Filed: May 24, 2024

(51) Int. Cl. C04B 28/14; C04B 14/06; C04B 24/12; C04B 24/26; C04B 103/20; C04B 111/00; C04B 111/70

(52) U.S. Cl. CPC C04B 28/14; C04B 14/06; C04B 24/123; C04B 24/2623; C04B 2103/20; C04B 2111/00663; C04B 2111/70

(57) ABSTRACT

A grout composition for use in construction is disclosed. The grout composition includes a binder, a filler, a retarder, and a polymer. The binder includes calcium sulfate, the filler includes natural sand, the retarder includes modified amino acid, and the polymer includes vinyl acetate. The grout composition provides a shrink-free gap filler. Further, a method of preparing a grout is also disclosed. The method includes preparing the grout composition. The method further includes mixing the grout composition with a predetermined amount of water in a mixer for a predetermined amount of time to form grout having a predetermined consistency for a structural application.

### FIELD OF THE INVENTION

The present disclosure generally relates to grout compositions formulated for structural applications as grout mixtures as well as methods of using these compositions. In particular, the present disclosure relates to an innovative, eco-friendly, non-shrink, cement-free (green) grout composition that when hydrated produces a grout mixture having high strength and free-flowing property.

### BACKGROUND OF THE INVENTION

Builders of both commercial and non-commercial buildings are constantly looking for new innovative products and materials in order to make buildings more environmentally friendly and energy efficient, to better protect them from the weather, and to make them more aesthetically pleasing, among other like objects.

One building material that is commonly used in structural applications is a grout mixture. It is generally used for filling gaps in tiles, sealing joints, and the like. However, commercially available grout mixtures are cement-based and are, therefore, prone to shrinkage that can make a joint unstable and thus, may not support high load transfers between precast elements. Additionally, they are prone to stains due to their metallic nature. Further, such commercially available grout mixtures may not exhibit multiple fluidity consistencies by only adjusting water addition without major changes in properties.

Therefore, new and improved grout compositions are needed for use in structural applications. The present disclosure provides such compositions as well as methods of making and using these compositions in construction activities.

### SUMMARY OF THE INVENTION

The following represents a summary of some embodiments of the present disclosure to provide a basic understanding of various aspects of the disclosed herein. This summary is not an extensive overview of the present disclosure. It is not intended to identify key or critical elements of the present disclosure or to delineate the scope of the present disclosure. Its sole purpose is to present some embodiments of the present disclosure in a simplified form as a prelude to the more detailed description that is presented below. Embodiments of grout compositions and methods for manufacturing and using them in construction to address at least some of the above challenges and issues are disclosed.

In some aspects, the present disclosure is directed to a grout composition for use in construction. The grout composition includes a binder comprising calcium sulfate, a filler comprising natural sand, a retarder comprising modified amino acid, and a polymer comprising vinyl acetate.

In some embodiments, a quantity of the calcium sulfate is between 50-60% of the grout composition by weight, a quantity of the natural sand is between 40-50% of the grout composition by weight, a quantity of the modified amino acid is between 0.001-0.01% of the grout composition by weight, and a quantity of the vinyl acetate is between 1-2% of the grout composition by weight.

In some embodiments, the grout composition is mixed with a predetermined amount of water in a mixer for a predetermined amount of time to form grout for a structural application. A flowability of the grout is controlled by varying the predetermined amount of water.

In some embodiments, the predetermined amount of water is added such that a water-to-grout composition ratio of the grout is between 0.16-0.18 and a plastic consistency of the grout is within a first predetermined range.

In some embodiments, the predetermined amount of water is added such that a water-to-grout composition ratio of the grout is between 0.18-0.20 and a fluid consistency of the grout is within a second predetermined range.

In some embodiments, the grout is applied between joints of precast concrete elements such that the grout makes the joints stable and enables improved load transfers between the precast concrete elements.

In some embodiments, the grout is nonmetallic.

In some embodiments, the grout composition is cement-free.

In some embodiments, properties of the grout composition include one or more of a compressive strength of more than 15 MPa (that further refers to one-day strength), a flexural strength of more than 5 MPa, a thermal expansion in the range of 0 to 0.025%, a flowability of between 100-125%, a plastic consistency of between 125-150%, a flowable fluid of between 60-90 seconds, setting time of between 3-6 hours, and a modulus of elasticity of more than 8 GPa.

In some aspects, the present disclosure is further directed to a method of preparing a grout. The method includes preparing a grout composition comprising a binder having calcium sulfate, a filler having natural sand, a retarder having modified amino acid, and a polymer having vinyl acetate. The method further includes mixing the grout composition with a predetermined amount of water in a mixer for a predetermined amount of time to form grout having a predetermined consistency for a structural application. The grout is a shrink-free gap filler.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Further advantages of the disclosure will become apparent by reference to the detailed description of preferred embodiments when considered in conjunction with the drawings. In the drawings, identical numbers refer to the same or a similar element.

FIG. 1 illustrates ingredients collated in the form of a group that make up an exemplary grout composition, in accordance with some embodiments of the present disclosure.

FIG. 2 illustrates an arrangement for manufacturing a grout composition, in accordance with some embodiments of the present disclosure.

FIG. 3 illustrates the steps of a method for manufacturing and using grout composition for construction activities, in accordance with some embodiments of the present disclosure.

### DETAILED DESCRIPTION

The following detailed description is presented to enable any person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown, but is to be accorded the widest possible scope consistent with the principles and features disclosed herein.

Embodiments of the present solution provide new and improved grout compositions, with many advantages, such as quick setting time, non-shrinkage, high adhesion to concrete surfaces, multiple fluidity, high stability, and satisfactory finishing, in structural applications. The present disclosure provides a specially formulated grout mixture that is cement-free and has shrinkage compensating properties in both plastic and hardened states with good adhesion to concrete surface. Further, such specially formulated grout mixture is one-component grout with high strength and is ready to use with free-flowing property.

Grout composition in accordance with the embodiments is different from conventional grouts. This difference is based both on use as well as composition. In some embodiments, such grout composition includes a specific form of calcium sulfate, such as calcium sulfate alpha hemihydrate. Further, such grout composition includes natural sand as a filler that acts as a shrink-free gap filler. The grout composition also includes retarders such as modified amino acids. Further, the grout composition also includes a polymer, such as vinyl acetate. Unlike the conventional grout compositions, the grout composition, as disclosed in various embodiments of the disclosure, does not contain slag, fly ash, silica fume, water glass solution, NaOH, coal gangue powder, polyol, latex, and the like.

Some embodiments provide several other objects and advantages, some of which are discussed below. The grout composition has been specially formulated to have shrink-free properties. Non-shrink properties make the joint stable and enable high load transfers between the precast concrete elements. At the same time, the grout composition, as disclosed in various embodiments, is cement-free, therefore a green and sustainable material. Owing to such properties, the grout composition poses lower damages to ecosystems (due to lower carbon dioxide emissions) and resources (such as water), as compared to conventional cement-based products. Another advantage of the grout composition is that no water curing is necessary.

The grout composition and/or the resulting jointing compound, is multi-functional, and its application is not limited to gap filling between precast elements only. It is suitable for other gaps as well, such as, dowel tube filling in precast wall panels, joints between precast elements, and grouting of base plates. Further, the grout composition and/or the resulting grout mixture is alkaline and non-inflammable. It reduces the risk of construction workers' eye, skin, nose, and respiratory irritation. These and other like advantages make the disclosed embodiments more versatile, environmentally friendly, economical, and sustainable.

Certain terms and phrases have been used throughout the disclosure and will have the following meanings in the context of the ongoing disclosure.

“Concrete” for the purposes of the present disclosure refers to a hard strong building material.

“Cement” for the purposes of the present disclosure refers to a binder, a substance that sets and hardens and is able to bind other materials together. Cement is manufactured through a closely controlled chemical combination of calcium, silicon, aluminum, iron, and other ingredients. Common materials used to manufacture cement are able to include, but are not limited to, limestone, shells, and chalk or marl combined with shale, clay, slate, blast furnace slag, silica sand, and iron ore. Some of the types of cement are able to include, but are not limited to, hydraulic and elite cements, such as Portland Cement, blended cement, masonry cement, oil well cement, natural cement, alumina cement, expansive cement, and the like, and mixtures thereof.

“Gypsum” for the purposes of the present disclosure refers to a soft sulfate mineral composed of calcium sulfate alpha hemihydrate. Gypsum is widely used as a main constituent in many forms of grout. Gypsum board is primarily used as a finish for walls and ceilings. Gypsum is also referred to as plasterboard, sheetrock, or drywall in construction applications. Further, gypsum blocks are used similar to concrete blocks in building construction.

“Natural Sand” for the purposes of the present disclosure refers to a naturally occurring granular material composed of finely divided rock and mineral particles. Sand is able to be defined by size in being finer than gravel and coarser than silt. The composition of sand is able to vary depending on the local rock sources and conditions.

“Polymer” for the purposes of the present disclosure includes, but is not limited to, homopolymers, copolymers, graft copolymers, and blends and combinations thereof.

“Grout” for the purposes of the present disclosure refers to a composite material that is able to be used for filling voids under machines or other structural elements, sealing joints and the like.

“Calcium sulfate alpha hemihydrate” for the purposes of the present disclosure refers to the compound α-CaSO4·½H2O. The alpha-hemihydrate is produced from gypsum calcined in a steam-saturated atmosphere.

In accordance with some embodiments, the present disclosure is directed to a grout composition for use in construction. The grout composition is able to include a binder, a filler, a retarder, and a polymer. The binder includes calcium sulfate, the filler includes natural sand, the retarder includes modified amino acid, and the polymer includes vinyl acetate.

In some embodiments, the grout composition is able to exhibit various properties such as, but not limited to, non-shrinking, cement-free, high strength, good adhesion, stability, high load transferring capability, multiple fluidity, and sustainable (due to lesser environmental damage and adverse effects).

In some embodiments, the grout composition is able to be available in prepacked/prepackaged form, where water is added in an amount to produce a grout mixture having a predetermined consistency and workability. In some embodiments, the grout composition of the present disclosure is highly suitable for gap filling between precast elements, dowel tube filling in precast wall panels, joints between precast elements, and grouting of base plates, to name a few.

In some embodiments, the grout composition, so disclosed, is able to be used in one or more construction activities. For such embodiments, the grout composition is able to be added to water in a mixer. In some embodiments, the grout composition is able to be blended in the mixer for a predetermined amount of time at a predetermined speed until a grout mixture having a predetermined consistency and workability is achieved.

These and other embodiments are discussed in detail below.

In some embodiments, the present disclosure relates to a grout composition that includes a binder, a filler, a retarder, and a polymer. The binder includes calcium sulfate alpha hemihydrate, the filler includes natural sand, the retarder includes modified amino acid, and the polymer includes vinyl acetate.

In some embodiments, the grout composition, in accordance with the embodiments, includes calcium sulfate alpha hemihydrate because of the various advantages that it offers. For example, calcium sulfate alpha hemihydrate provides a high increase in gelation and reduced final setting times of the resulting mix, thereby improving productivity. In some embodiments, calcium sulfate alpha hemihydrate is able to be obtained from naturally available sources or is produced industrially. A person of ordinary skill in the art will understand that calcium sulfate alpha hemihydrate is typically prepared from gypsum. Calcium sulfate alpha hemihydrate for the purposes of the present disclosure refers to α-CaSO₄·½H₂O. Further, in an example, gypsum which is naturally available in solid form as deposits, undergoes many processes, such as (but not limited to) grinding and heating under high pressure to get the final α-CaSO₄·½H₂O in fine powder form in factories.

In some embodiments, the grout composition includes α-calcium sulfate hemihydrate (α-CaSO₄·½H₂O), where α-CaSO₄. In some embodiments, ½H₂O in the grout composition is between 50-60% of the grout composition by weight. This material acts like a binder and the quality of calcium sulfate alpha hemihydrate directly influences the properties, such as compressive strength, flexural strength, setting time, durability, such as, of the resulting grout composition. Calcium sulfate hemihydrate is able to react with other fundamental components of the grout composition, as mentioned above, to minimize or eliminate shrinkage cracks while imparting other useful properties to the disclosed grout composition. Further, calcium sulfate hemihydrate provides higher compressive strengths as compared to other forms of calcium sulfate. Furthermore, use of calcium sulfate hemihydrate in the grout composition results in a pH value of approximately 12 in the resulting mix, though other pH values are also contemplated. Early setting time is an intrinsic property of all calcium sulfates and calcium sulfate hemihydrates. Calcium sulfate hemihydrates typically lose their plasticity within 10 minutes of being mixed with water. Thus, in some embodiments, calcium sulfate hemihydrate is able to impart longer setting times with the aid of a retarder. The compressive strength of the obtained grout is able to be enhanced with calcium sulfate hemihydrate. All calcium sulfate hemihydrates are available in the market and are of different types. The pH values of all commercially available calcium sulfate hemihydrates vary. To get optimum results from the present grout composition, calcium sulfate hemihydrate with higher pH values (pH>10) is used in some embodiments. In some embodiments, two or more calcium sulfate hemihydrates are blended to obtain the required pH value in a given grout composition.

In some embodiments, the grout composition includes a filler comprising natural sand, where the quantity of the natural sand in the grout composition is between 40-60% of the grout composition by weight. Natural sand is a naturally occurring granular material composed of finely divided rock and mineral particles. Sand is able to be defined by size in being finer than gravel and coarser than silt. The composition of sand is able to vary depending on the local rock sources and conditions. The effect of natural sand is for sealing material that provides support skeleton and reduces cubic deformation.

Retarder(s) are polymer components that are used in some embodiments of the present grout composition. In some embodiments, a recommended percentage of the retarder is between 0.001-0.01% of the grout composition by weight. In some embodiments, retarders, such as modified amino acids, are used in the grout composition. Such retarders help to slow the hydration process of the grout composition. Further, the retarders provide excellent performance on increasing the initial setting time of the grout composition. The amounts of the retarders used depend on the type of retarder and are able to easily be determined by a person skilled in the art in accordance with the grout mixture requirements. A person of ordinary skill in the art will understand that other scenarios are also possible for the same. In some embodiments, the addition of a retarder is able to prolong the initial setting time. In one example, the initial setting time is between 45 to 60 minutes, though other times are also contemplated. In some embodiments, the initial setting time is customizable by adjusting the retarder dosage.

In some embodiments, the grout composition includes a polymer comprising vinyl acetate, where the quantity of the vinyl acetate in the grout composition is between 1-2% of the grout composition by weight. Such polymer is added to the grout material composition to significantly improve its properties, such as abrasion resistance and compressive strength. In some embodiments, vinyl acetate polymers are able to be prepared in a known manner by emulsion or dispersion polymerization. The polymer is able to be added in the form of the water-dispersible powders produced by drying the dispersions obtained in the polymerization and optionally mixed with additives to the grout material composition before molding, in particular together with the mixing water. The polymers of vinyl acetate are able to contain, as protective colloids, ionic and/or nonionic emulsifiers, which are usually present in such polymers from their production, or dispersants of the aforementioned classes that are mixed therewith.

Further, because of the hydrophobic properties of the polymer, the grout material composition and/or the grout material consumes lesser water as compared to conventional grouts. In some embodiments, the water binder ratio is between 0.16-0.18 with the addition of polymer.

In some embodiments, the grout composition sets rapidly by an amount of time, referred to as the final setting time, during which the grout composition loses its plasticity by a predetermined amount (such as, it changes from a plastic state to a solid state). In some embodiments, the final setting time of the grout composition ranges between three to six hours. In some embodiments, adding a retarder does not alter the final setting time for the grout composition.

Further, the present grout composition is able to be made available in a prepackaged form, and water is added in an amount that is able to be sufficient to produce grout mixture with a predetermined range of flowable consistency. In some embodiments, one package of the grout composition weighs around 1 ton. Typically, the shelf life of the grout composition is about 6 months from date of packaging, if stored properly, such as, stored at an elevated place on the ground or in a shed, away from moisture, and in some embodiments, at a temperature below 35° C. In some embodiments, the grain size of the grout composition is 0-4 mm and is of gray color. The pot life of the grout composition is minimum 30 minutes, and the pH value of the paste is 12, therefore highly alkaline. In some embodiments, each 25 kgs is able to yield 12 L of grout material. In addition, the grout composition has high thermal insulation and has high fire-resistance, among other like benefits. A person of ordinary skill in the art will understand that other configurations and scenarios are also possible for the composition.

In various embodiments, the grout material composition exhibits various properties. For example, the compressive strength for one day exceeds 15 Mpa. For 7 days and 28 days, the compressive strength exceeds 30 MPa and 45 MPa, respectively. The flexural strength exceeds 5 MPa at 28 days, for example. The thermal expansion is able to be at the most 0.025%. The modulus of elasticity exceeds 8 GPa. The flowability of the grout material is able to be between 100-125%, the plastic consistency is able to be between 125-150%, and a flowable fluid is able to be between 60-90 seconds.

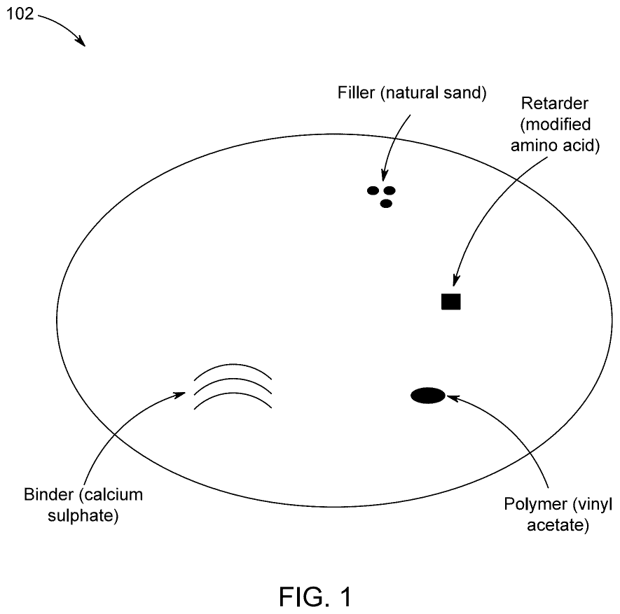

FIG. 1 illustrates ingredients collated in the form of a group 102 that make up an exemplary grout composition, in accordance with some embodiments of the present disclosure. In some embodiments, the ingredients are able to include, but are not limited to, a binder, filler(s), retarder(s), and polymer(s). Further, water is able to be added to the ingredients when making up the grout composition. Thus, in some embodiments, the group 102 is able to be used to manufacture the exemplary grout composition.

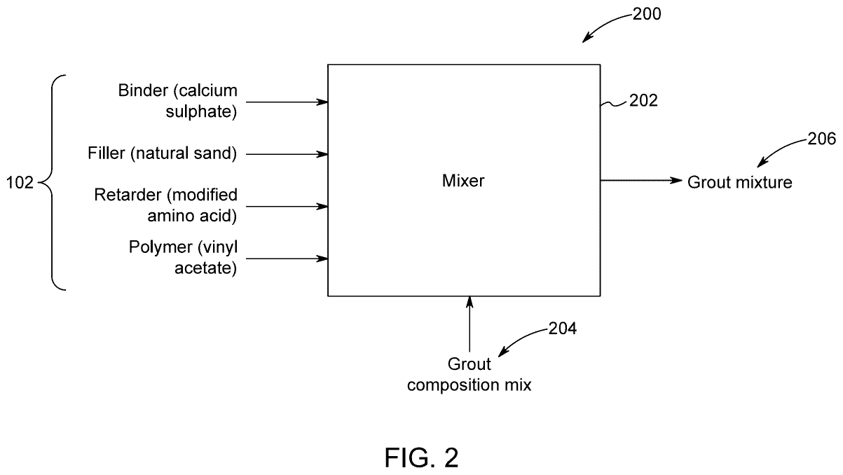

FIG. 2 illustrates an arrangement 200 for manufacturing grout composition, in accordance with some embodiments of the present disclosure.

The arrangement 200 includes a mixer 202 in which the inputs as the ingredients 102 of the grout composition are mixed with a predetermined amount of water for a predetermined amount of time to form a grout composition mix 204, or simply “grout”, for a structural application. The ingredients 102 include a binder, filler(s), retarder(s), and polymer(s). In some embodiments, the binder includes calcium sulfate or more specifically, calcium sulfate alpha hemihydrate gypsum, the filler includes natural sand, the retarder includes modified amino acid, and the polymer includes vinyl acetate. In some embodiments, all these ingredients 102 are added in the mixer 202 in appropriate quantities for a mechanical mixing according to the desired grout composition. The table below (Table 1) indicates the appropriate quantities of the components of the grout composition in accordance with some embodiments. The quantities indicated in Table 1 are non-limiting. Other ingredients and quantities are contemplated.

TABLE 1

| Component | Quantity |
|---|---|
| Calcium sulfate (alpha hemihydrate | Between 50-60% of the grout |
| gypsum) | composition by weight |
| Filler (natural sand) | Between 40-50% of the grout |
| | composition by weight |
| Retarder (modified amino acid) | Between 0.001-0.01% of the |
| | grout composition by weight |
| Polymer (vinyl acetate) | Between 1-2% of the grout |
| | composition by weight |

In some embodiments, the predetermined amount of water is added to the mixer 202 first, followed by the input ingredients 102 of the grout composition. The mixer 202 is able to be operated at a normal speed for a predetermined amount of time based on a type of mixing and batch size, until a consistent and workable grout composition mix 204 is obtained. The grout composition mix 204 is cement-free, nonmetallic, sustainable, and non-shrink. This consistent and workable grout composition mix 204 corresponding to the grout composition is able to be used for various purposes, such as, but not limited to, for filling gaps or joints between precast elements, for filling dowel tube in precast wall panels, for grouting of base plates, to name only a few examples.

In some embodiments, the predetermined amount of water is added such that a water-to-grout composition ratio of the grout composition mix 204 is between 0.16-0.18 and a plastic consistency of the grout composition mix 204 is within a first predetermined range. In some embodiments, the predetermined amount of water is added such that a water-to-grout composition ratio of the grout composition mix 204 is between 0.18-0.20 and a fluid consistency of the grout composition mix 204 is within a second predetermined range.

In an exemplary use case, the grout composition mix 204 is applied between joints of precast concrete elements such that the grout composition mix 204 makes the joints stable and enables improved load transfers between the precast concrete elements.

A person of ordinary skill in the art will understand that the mixer 202 is able to correspond to a mixer that mixes wet (such as, water) and dry materials (such as, grout composition mix 204) to produce a resulting mix (such as, the grout mixture 206) at a construction site. In some embodiments, the mixer 202 is able to correspond to an apparatus or device that includes, but is not limited to, a batch mixer such as, a drum type mixer and a pan type mixer, and a continuous mixer, which are able to be used for the present disclosure. A person of ordinary skill in the art will understand that other configurations are also possible for the mixer 202, without deviating from the scope of the disclosure.

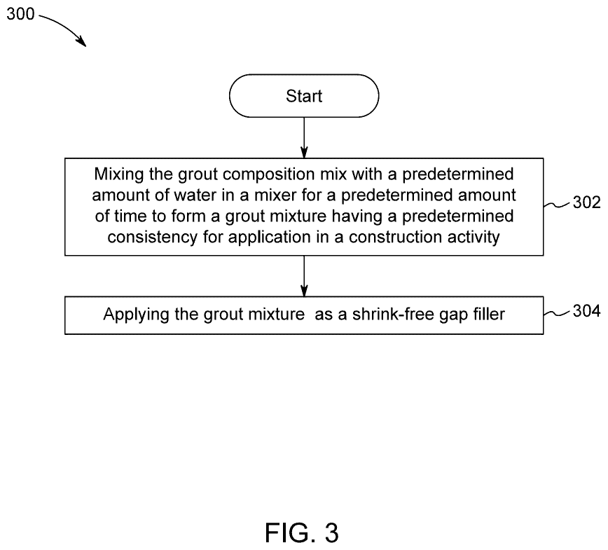

FIG. 3 illustrates a flowchart specifying the steps of a method 300 for manufacturing grout composition for construction activities, in accordance with some embodiments of the present disclosure. The grout composition described herein is able to be equivalent to the grout composition mix 204 of FIG. 2 in its functionality and characteristics, as described above.

Although specific operations are disclosed herein, such operations are examples and are non-limiting. In different embodiments, to name only a few examples, the method 300 includes other steps, the sequence of the steps is modified, some steps are omitted, or any combination of these variations are able to be incorporated. The steps of the method 300 are able to be automated or semi-automated. In various embodiments, one or more of the operations of the method 300 are able to be controlled or managed by software, by firmware, by hardware, or by any combination thereof.

In some embodiments, the method 300 includes processes in accordance with the present disclosure which are able to be controlled or managed by a processor(s) and electrical components under the control of a computer or computing device comprising computer-readable media containing non-transitory computer-executable instructions or code that when executed by the processor(s) perform the steps of the method 300. The readable and executable instructions (or code) are able to reside, for example, in data storage such as volatile memory, non-volatile memory, and/or mass data storage, as only some examples. In some embodiments, automation of the method 300 through a computer employs various peripherals such as sensors, robotic arms, and the like.

Referring to FIG. 3, at a step 302, a predetermined amount of water is added to the mixer 202 followed by addition of the ingredients 102 of the grout composition mix 204 to the mixer 202 to form the grout mixture 206 with a predetermined range of flowable consistency and workability. In some embodiments, the grout composition mix 204 includes the binder, the filler, the retarder, and the polymer. In some embodiments, the binder includes calcium sulfate or more specifically, calcium sulfate alpha hemihydrate gypsum, the filler includes natural sand, the retarder includes modified amino acid, and the polymer includes vinyl acetate. Accordingly, a consistent and workable grout composition mix 204, is obtained that is cement-free. In some embodiments, a predetermined amount of time for which the grout composition is blended in the mixer 202 is able to vary from 3 to 5 minutes, though other times are also contemplated.

In some embodiments, the grout mixture 206 is mixed for a predetermined amount of time based on a type of mixing and batch size such that a consistency of the grout mixture 206 within a predetermined range is obtained. In some embodiments, when ambient temperature is above 40 degree Celsius, the temperature of the predetermined amount of water is able to be mechanically cooled to be within a predetermined range. In such case, the predetermined amount of water is mechanically cooled to be within the predetermined range so as to reduce internal grout temperature.

It is to be noted that the amount of water is able to be predetermined based on a type of consistency required for a specific constructional requirement. In one exemplary embodiment, water-to-grout composition ratio of the grout mixture is between 0.16-0.18 such that a plastic consistency of the grout mixture is within a first predetermined range. In another exemplary embodiment, water-to-grout composition ratio of the grout mixture is between 0.18-0.20 such that a flowable and fluid consistency of the grout mixture is within a second predetermined range. The table below (Table 2) indicates the appropriate ratios and quantities of water and grout composition in accordance with some embodiments.

TABLE 2

| Type of Consistency | Ratio | Quantities |
|---|---|---|
| Plastic Consistency | 0.16-0.18 | 4-4.5 liters to 25 kgs of the grout |
| | | composition |
| Flowable and Fluid | 0.18-0.2 | 4.5-5 liters to 25 kgs of the grout |
| Consistency | | composition |

At step 304, the grout mixture 206 is applied onto an application area that is able to be one or more of gap filling between precast elements, dowel tube filling in precast wall panels, joints between precast elements, and grouting of base plates, to name a few. For the applied grout mixture 206, no water curing is necessary.

Embodiments of the proposed grout composition and the methods of making and using them provide a versatile, sustainable, economical, and environmentally friendly product. A mix of the proposed grout composition, in accordance with some embodiments, does not contain cement or any cementitious binder, and thus, are green materials. The proposed grout composition mix 204 and/or the resulting grout mixture 206 is a non-shrink general purpose and one component grout with high strength. The non-shrink property of the proposed grout composition mix 204 and/or the resulting grout mixture 206 makes the joints stable and enables high load transfers between precast elements. The proposed grout composition mix 204 and/or the resulting grout mixture 206 is specially formulated to have shrinkage compensating properties in both plastic and hardened states with good adhesion to concrete surfaces. Further, the proposed grout composition mix 204 and/or the resulting grout mixture 206 is ready to use with free-flowing property. Multiple fluidity consistencies are able to be achieved for the proposed grout composition mix 204 and/or the resulting grout mixture 206 just by adjusting water addition without major changes in properties. Furthermore, the proposed grout composition and/or the resulting grout mixture 206 has a nonmetallic nature. From the aspect of sustainability, the proposed grout composition mix 204 and/or the resulting grout mixture 206 have significantly lower damage to human health and the ecosystem compared with conventional grout mixtures. In terms of other environmental problems and water consumption, the proposed grout composition and/or the resulting grout mixture 206 has a lower impact, as compared with cement-based product. For example, the proposed grout composition mix 204 and/or the resulting grout mixture 206 emits 67% lower CO₂ to the atmosphere (for example, 148 gr CO₂ eq/kg) compared with cement-based product (for example, 455 gr CO₂ eq/gr). These and other like advantages make the disclosed embodiments a multifunctional and improved grout composition mix 204 and/or the resulting grout mixture 206.

In some embodiments, a system (in an example, a computer) for performing the steps of method 300 is automated. In some embodiments, the computer is able to comprise a memory storing computer-executable instructions that when executed by a processor(s) perform the steps of method 300.

The terms “comprising,” “including,” and “having,” as used in the specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention. The term “connecting” includes connecting, either directly or indirectly, and “coupling,” including through intermediate elements.

The disclosure has been described with reference to various specific and preferred embodiments and techniques. However, it should be understood that many variations and modifications may be made while remaining within the spirit and scope of the disclosure. It will be apparent to one of ordinary skill in the art that methods, devices, device elements, materials, procedures, and techniques other than those specifically described herein can be applied to the practice of the disclosure as broadly disclosed herein without resort to undue experimentation. All art-known functional equivalents of methods, devices, device elements, materials, procedures, and techniques described herein are intended to be encompassed by this disclosure. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the building blocks described herein contain optional features that can be individually or together applied to any other embodiment shown or contemplated here to be mixed and matched with the features of that building block.

While the disclosure has been described with respect to a limited number of embodiments, those skilled in the art, having benefit of this disclosure, will appreciate that other embodiments can be devised which do not depart from the spirit and scope of the disclosure as disclosed herein.

We claim:

1. A grout composition for use in construction, comprising:
a binder comprising calcium sulfate;
a filler comprising natural sand;
a retarder comprising modified amino acid; and
a polymer comprising vinyl acetate,
wherein the grout composition provides a shrink-free gap filler.

2. The grout composition of claim 1, wherein:
a quantity of the calcium sulfate is between 50-60% of the grout composition by weight;
a quantity of the natural sand is between 40-50% of the grout composition by weight;
a quantity of the modified amino acid is between 0.001-0.01% of the grout composition by weight; and
a quantity of the vinyl acetate in the grout composition is between 1-2% of the grout composition by weight.

3. The grout composition of claim 1, wherein the grout composition is mixed with a predetermined amount of water in a mixer for a predetermined amount of time to form grout for a structural application,
wherein a flowability of the grout is controlled by varying the predetermined amount of water.

4. The grout composition of claim 3, wherein the predetermined amount of water is added such that a water-to-grout composition ratio of the grout is between 0.16-0.18 and a plastic consistency of the grout is within a first predetermined range.

5. The grout composition of claim 3, wherein the predetermined amount of water is added such that a water-to-grout composition ratio of the grout is between 0.18-0.20 and a fluid consistency of the grout is within a second predetermined range.

6. The grout composition of claim 3, wherein the grout is applied between joints of precast concrete elements such that the grout makes the joints stable and enables improved load transfers between the precast concrete elements.

7. The grout composition of claim 3, wherein the grout is nonmetallic.

8. The grout composition of claim 1, wherein the grout composition is cement-free.

9. The grout composition of claim 1, wherein properties of the grout composition comprise one or more of:
a compressive strength of more than 15 MPa;
a flexural strength of more than 5 MPa;
a thermal expansion in the range of 0 to 0.025%;
a flowability of between 100-125%;
a plastic consistency of between 125-150%;
a flowable fluid of between 60-90 seconds;
a setting time of between 3-6 hours; and
a modulus of elasticity of more than 8 GPa.

10. A method of preparing a grout, the method comprising:
preparing a grout composition comprising a binder having calcium sulfate, a filler having natural sand, a retarder having modified amino acid, and a polymer having vinyl acetate; and
mixing the grout composition with a predetermined amount of water in a mixer for a predetermined amount of time to form grout having a predetermined consistency for a structural application,
wherein the grout is a shrink-free gap filler.

11. The method of claim 10, wherein:
a quantity of the calcium sulfate is between 50-60% of the grout composition by weight;
a quantity of the natural sand is between 40-50% of the grout composition by weight;
a quantity of the modified amino acid is between 0.001-0.01% of the grout composition by weight; and
a quantity of the vinyl acetate in the grout composition is between 1-2% of the grout composition by weight.
